(19) United States
(12) Patent Application Publication
(10) Pub. No.: US 2018/0183532 A1
(43) Pub. Date: Jun. 28, 2018

(54) MODULATION FORMAT SELECTION FOR MILLIMETER-WAVE OPERATION IN THE PRESENCE OF PHASE NOISE

(71) Applicant: INTEL CORPORATION, SANTA CLARA, CA (US)

(72) Inventor: CLAUDIO DA SILVA, San Ramon, CA (US)

(73) Assignee: INTEL CORPORATION, SANTA CLARA, CA (US)

(21) Appl. No.: 15/390,381

(22) Filed: Dec. 23, 2016

(51) Int. Cl. H04B 17/336; H04B 7/06

(52) U.S. Cl. CPC H04B 17/336; H04W 84/12; H04B 7/0632

(57) ABSTRACT

Techniques for modulation format selection for millimeter-wave communication systems in the presence of phase noise are provided. A phase noise level of a remote device can be determined. The signal-to-interference-plus-noise ratio (SINR) for the remote device can also be determined. A modulation format for the remote device can be determined based on the phase noise level and the SINR for the remote device. A signal for transmission to the remote device can be generated based on the selected modulation format. Other embodiments are described and claimed.

### TECHNICAL FIELD

Embodiments described herein generally relate to wireless communications between devices in wireless networks.

### BACKGROUND

The phase noise level of oscillators and/or phase-locked loops used in millimeter-wave communication systems can be significantly higher than the phase noise levels that occur in wireless systems that operate in the ultra-high frequency (UHF) and microwave bands. Conventional millimeter-wave communication systems, however, do not account for the different phase noise levels of the various users. Accordingly, new techniques for accommodating users with different phase noise profiles by adjusting modulation formats for each user may be needed.

### BRIEF DESCRIPTION OF THE DRAWINGS

FIG. 1 illustrates an embodiment of a first operating environment.

FIG. 2 illustrates a first comparison of a single-carrier frequency domain equalization (SC-FDE) system and an orthogonal frequency-division multiplexing (OFDM) system.

FIG. 3 illustrates a second comparison of an SC-FDE system and an OFDM system.

FIG. 4 illustrates a third comparison of an SC-FDE system and an OFDM system.

FIG. 5 illustrates a fourth comparison of an SC-FDE system and an OFDM system.

FIG. 6 illustrates a fifth comparison of an SC-FDE system and an OFDM system.

FIG. 7 illustrates a sixth comparison of an SC-FDE system and an OFDM system.

FIG. 8 illustrates a first table for selecting a modulation format for a user in a millimeter-wave wireless system.

FIG. 9 illustrates a second table for selecting a modulation format for a user in a millimeter-wave wireless system.

FIG. 10 illustrates an embodiment of a first logic flow.

FIG. 11 illustrates an embodiment of a storage medium.

FIG. 12 illustrates an embodiment of a device.

FIG. 13 illustrates an embodiment of a wireless network.

### DETAILED DESCRIPTION

Various embodiments may be generally directed to modulation format selection techniques for millimeter-wave communication systems in the presence of phase noise. Various embodiments provide for phase noise level of a remote device to be determined. The signal-to-interference-plus-noise ratio (SINR) for the remote device can also be determined. A modulation format for the remote device can be determined based on the phase noise level and the SINR for the remote device. A signal for transmission to the remote device can be generated based on the selected modulation format. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Various embodiments herein are generally directed to wireless communications systems. Some embodiments are particularly directed to wireless communications over 31.8 GHz and/or 60 GHz frequencies. Various such embodiments may involve wireless communications performed according to one or more standards for 60 GHz wireless communications and/or wireless communications over 31.8 GHz. For example, some embodiments may involve wireless communications performed according to one or more Wireless Gigabit Alliance (“WiGig”)/Institute of Electrical and Electronics Engineers (IEEE) 802.11ad standards, such as IEEE 802.11ad-2012, including their predecessors, revisions, progeny, and/or variants. Various embodiments may involve wireless communications performed according to one or more “next-generation” 60 GHz (“NG60”) wireless local area network (WLAN) communications standards, such as the IEEE 802.11 ay standard that is currently under development. Some embodiments may involve wireless communications performed according to one or more millimeter-wave (mmWave) wireless communication standards. It is worthy of note that the term “60 GHz” (or any specific frequency), as it is employed in reference to various wireless communications devices, wireless communications frequencies, and wireless communications standards herein, is not intended to specifically denote a frequency of exactly 60 GHz (or any other specific frequency), but rather is intended to generally refer to frequencies in, or near, the 57 GHz to 64 GHz frequency band or any nearby unlicensed band. The embodiments are not limited in this context.

In general, various embodiments herein may involve millimeter-wave communications systems. Various embodiments herein may involve systems operating according to any known wireless standard or protocol or any wireless standard or protocol under development including, but not limited to, IEEE 802.11ad, IEEE 802.11ay, and any 5G system.

Various embodiments may additionally or alternatively involve wireless communications according to one or more other wireless communication standards. Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

Further examples of wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11af, and/or IEEE 802.11ah standards, High-Efficiency Wi-Fi standards developed by the IEEE 802.11 High Efficiency WLAN (HEW) Study Group and/or IEEE 802.11 Task Group (TG) ax, Wi-Fi Alliance (WFA) wireless communication standards such as Wi-Fi, Wi-Fi Direct, Wi-Fi Direct Services, WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above. The embodiments are not limited to these examples.

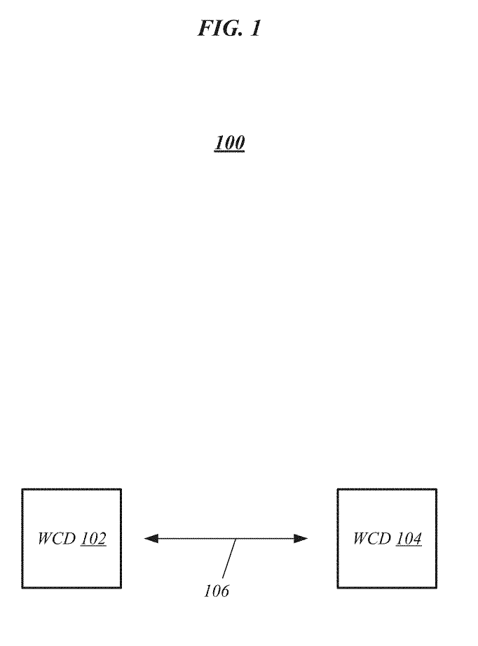

FIG. 1 illustrates an exemplary operating environment 100 such as may be representative of various embodiments in which techniques for selecting modulation format for millimeter-wave operation in the presence of phase noise are implemented. The operating environment 100 can include a wireless communication device (WCD) 102 and a WCD 104. The WCD 102 and the WCD 104 can communicate with one another over a wireless communications interface 106. The wireless communications interface 106 can be, for example, a wireless interface for any of the wireless networks or standards described herein including, for example, a millimeter-wave communication standard including an IEEE 802.11 standard such as, for example, 802.11ad or 802.11ay, or a 5G communication standard. In various embodiments, the wireless interface 106 may operate within a 60 GHz frequency band and/or any band over 31.8 GHz.

In various embodiments, at least one of the WCDs 102 and 104 may operate as a station (STA) and at least one of the WCDs 102 and 104 may operate as a personal basic service set (PBSS) control point (PCP) or infrastructure basic service set (BSS) access point (AP). One or more of the WCDs 102 and 104 can be, for example, a mobile computing device. As an example, the WCDs 102 and/or 104 can be any mobile computing device capable of communicating wirelessly over one or more wireless communication networks. In various embodiments, at least one of the WCDs 102 and 104 can be a user equipment (UE) and at least one of the WCDs 102 and 104 can be a cellular base station such as, for example, an evolved node B (eNB). In various embodiments described herein, the WCD 102 can be considered to be a base station (e.g., an access point or cellular base station) and the WCD 104 can be considered to be a remote mobile device (e.g., a station or UE) with the WCDs 102 and 104 operating within a millimeter-wave communication system of which the operating environment 100 is a part. The WCD 102 and the WCD 104 can implement the modulation format selection techniques described herein. The embodiments are not limited in this context.

In millimeter-wave communication systems, such as a millimeter-wave communication system in which WCDs 102 and 104 may operate in, the phase noise level of oscillators and/or phase-locked loops (PLLs) (e.g., synthesizers) that may be used may be significantly higher than that of traditional wireless systems that may operate in the ultra-high frequency (UHF) or microwave bands. As a result, millimeter-wave systems must contend with high phase noise levels and accommodate users with different phase noise profiles or levels. Different modulation formats—for example, in terms of employing variations of single-carrier frequency domain equalization (SC-FDE), orthogonal frequency-division multiplexing (OFDM), uniform and non-uniform constellations, large and small modulation orders, discrete Fourier transform (DFT) size and sub-carrier spacing—can be affected differently by phase noise. Accordingly, in many operating situations, the most appropriate modulation format for a given user can depend in part on the user's phase noise profile.

Techniques described herein provide for the base station or access point of a wireless system to select (1) modulation scheme (e.g., SC-FDE and OFDM), (2) constellation size and shape (e.g., M-ary quadrature amplitude modulation (M-QAM), uniform or non-uniform constellation), and (3) symbol length (DFT size/sub-carrier spacing) of the signal transmitted to a given user based on that particular user's category and/or feedback. The user's category and/or feedback can be determined at least in part by its phase noise profile, including power level.

Conventional wireless standards and/or communication systems typically define the modulation scheme (e.g., modulation and coding scheme (MCS) including, for example, SC-FDE or OFDM) used to serve a given user based mostly, if not exclusively, only on the user's channel condition. In contrast to these conventional approaches, the techniques described herein can be used to categorize users at least in part by their phase noise profile, and the modulation format (and related parameters) used to serve the users can be chosen accordingly to each user's category and/or feedback.

Conventional radio-frequency integrated circuits (RFICs) for millimeter-wave systems show phase noise levels that are significantly higher than the levels for traditional wireless systems in the UHF and microwave bands. Phase noise levels of around −80 to −90 dBc/Hz at 1 MHz offset have been observed for conventional millimeter-wave PLL synthesizers, for example (dBc representing decibels relative to a carrier). As a result, the center frequency tolerance for conventional millimeter-wave standards is relatively quite high (e.g., ±20 parts per million (ppm) maximum for 802.11ad) when compared to lower-frequency systems.

Currently, it is not practical to construct millimeter-wave PLL synthesizers with low-level phase noise. Therefore, millimeter-wave devices generally may require the use of tracking and compensation methods that are robust to high phase noise levels. The use of tracking and compensation methods that are robust to high phase noise levels are typically needed for both multi-carrier (e.g., OFDM) and single-carrier millimeter-wave systems. In OFDM systems, the distortion introduced by phase noise creates a common phase error (i.e., a common phase shift for all subcarriers) and inter carrier interference. As a result, reliable mitigation schemes for OFDM systems can be quite complex and may involve decision-directed estimation and/or adaptive joint estimation. While single-carrier systems are in principle more robust to phase noise (e.g., since there is no inter carrier interference), phase noise can still also severely degrade single-carrier systems that employ frequency-domain equalization (e.g., SC-FDE). In certain circumstances, SC-FDE systems can be just as sensitive to phase noise as OFDM systems.

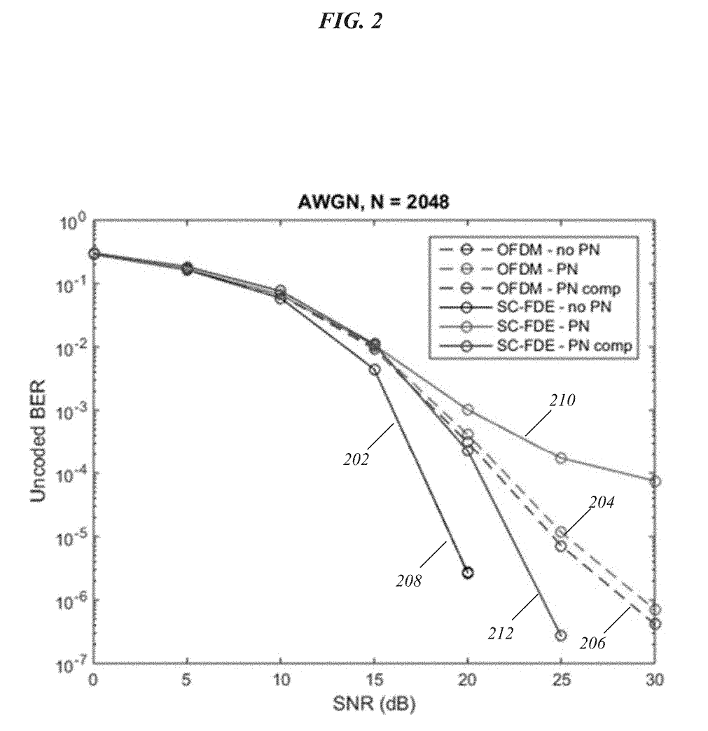

FIG. 2 illustrates the performance of SC-FDE and OFDM systems in the presence of phase noise for a first DFT size and assuming an additive white Gaussian noise (AWGN) channel. Specifically, the systems shown in FIG. 2 use a DFT size of 2048. Plot 202 shows the performance of an OFDM system with no phase noise. Plot 204 shows the performance of an OFDM system with phase noise. Plot 206 shows the performance of an OFDM system with phase noise compensation. Plot 208 shows the performance of an SC-FDE system with no phase noise (the plots 202 and 208 are approximately overlapping). Plot 210 shows the performance of an SC-FDE system with phase noise. Plot 212 shows the performance of an SC-FDE system with phase noise compensation.

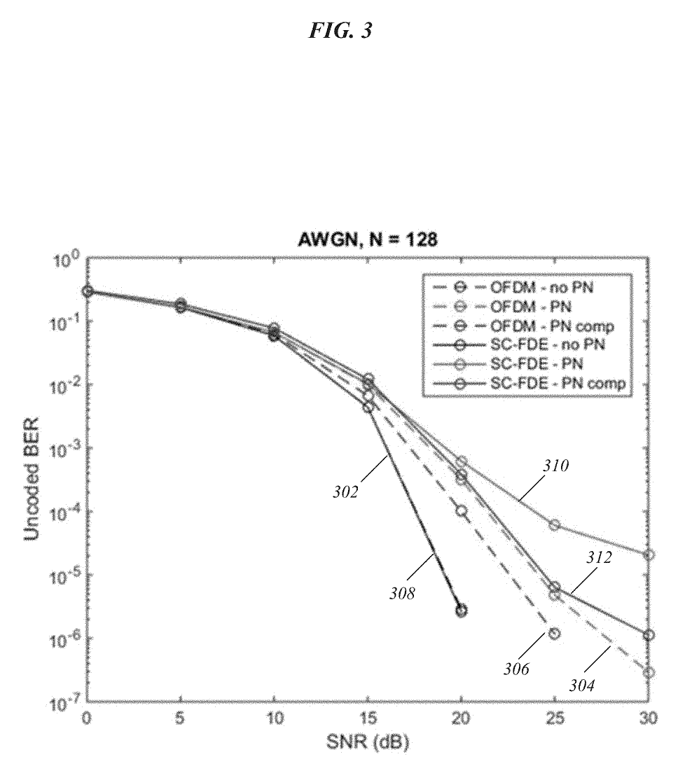

FIG. 3 illustrates the performance of SC-FDE and OFDM systems in the presence of phase noise for a second DFT size and assuming an additive white Gaussian noise (AWGN) channel. Specifically, the systems shown in FIG. 3 use a DFT size of 128. Plot 302 shows the performance of an OFDM system with no phase noise. Plot 304 shows the performance of an OFDM system with phase noise. Plot 306 shows the performance of an OFDM system with phase noise compensation. Plot 308 shows the performance of an SC-FDE system with no phase noise (the plots 302 and 308 are approximately overlapping). Plot 310 shows the performance of an SC-FDE system with phase noise. Plot 312 shows the performance of an SC-FDE system with phase noise compensation.

In general, FIGS. 2 and 3 show system performance when an appropriate phase noise compensation technique is used for both OFDM and SC-FDE systems. In particular, FIGS. 2 and 3 illustrate the performance of SC-FDE and OFDM systems when phase noise is either (1) tracked and mitigated (labeled as “PN comp”) or (2) not mitigated (labeled as “PN”) for different DFT sizes (either 2048 or 128). Further, in FIGS. 2 and 3, the modulation scheme used to simulate the performance plots was set to 16-QAM and the channel model was set to be AWGN.

A number of results can be seen from the plots provided in FIGS. 2 and 3. First, for a large DFT size (e.g., 2048; see FIG. 2), OFDM systems generally outperform SC-FDE when phase noise is not compensated for (compare plot 204 to plot 210). However, if the SC-FDE system employs phase noise mitigation, it generally outperforms OFDM (compare plot 206 to plot 212). The performance improvement obtained by an SC-FDE systems can be considerable when a phase noise mitigation scheme is used (compare plot 210 to plot 212).

Second, for a shorter DFT size (e.g., 128; see FIG. 3), which can correspond to a relatively larger sub-carrier spacing for an OFDM system, the OFDM system outperforms the SC-FDE system, both when PN is mitigated and is not mitigated (compare plot 306 to plot 312 and plot 304 to plot 310). FIG. 3 shows that while phase noise mitigation can improve the performance of SC-FDE systems in general, the improvement obtained is generally not enough to close the gap to the performance of a comparable OFDM system.

Accordingly, for an AWGN channel, it may be advantageous to use SC-FDE instead of OFDM for larger symbol lengths (i.e., DFT size) if a high level of phase noise is present. For shorter symbol lengths (i.e., larger sub-carrier spacing), it may be advantageous to use OFDM. If the phase noise level is low/almost negligible (see the “no phase noise” curves—plots 202 and 208 and plots 302 and 308), there may be no substantial difference in performance between SC-FDE and OFDM, as expected.

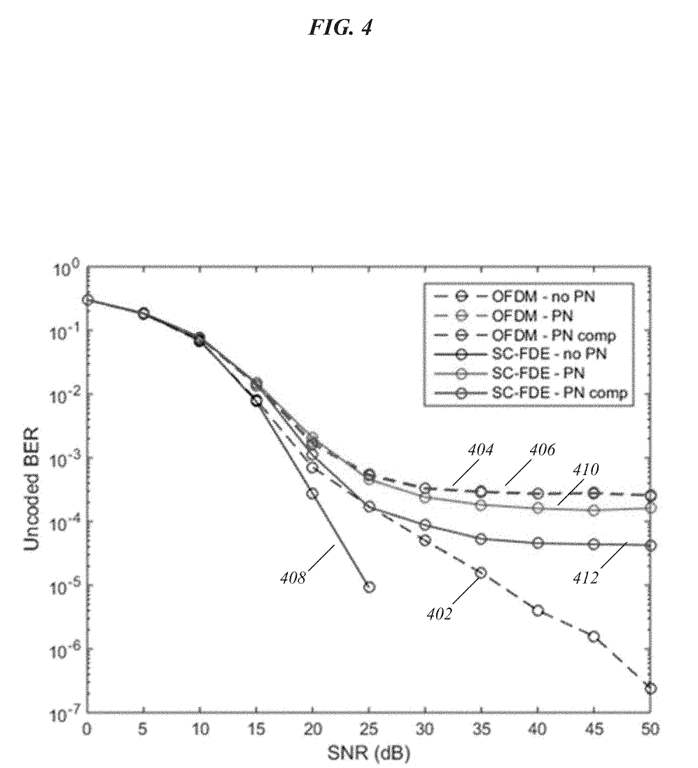

FIGS. 4-7 illustrate comparisons between the performance of SC-FDE and OFDM systems when phase noise is either tracked and mitigated (labeled as “PN comp”) or not mitigated (labeled as “PN”) for different channel conditions and DFT sizes. The channel models used to generate the performance results shown in FIGS. 4-7 included model IEEE 802.15.3c (LoS CM3.1, NLoS CM4.2). QPSK and 16-QAM were also used. Further details on these figures are provided below.

FIG. 4 illustrates the performance of SC-FDE and OFDM systems in the presence of phase noise for a line of sight (LOS) channel, a large DFT size (2048), with 16-QAM. Plot 402 shows the performance of an OFDM system with no phase noise. Plot 404 shows the performance of an OFDM system with phase noise. Plot 406 shows the performance of an OFDM system with phase noise compensation (plot 404 and 406 are approximately overlapping). Plot 408 shows the performance of an SC-FDE system with no phase noise. Plot 410 shows the performance of an SC-FDE system with phase noise. Plot 412 shows the performance of an SC-FDE system with phase noise compensation.

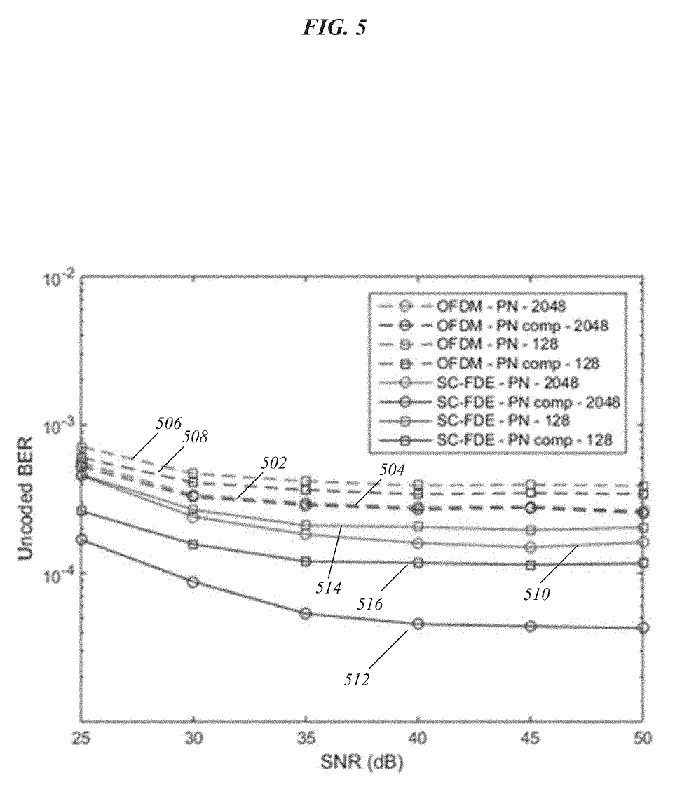

FIG. 5 illustrates the performance of SC-FDE and OFDM systems in the presence of phase noise for a line of sight (LOS) channel, with a large DFT size (2048) and a small DFT size (128), with 16-QAM. Plot 502 shows the performance of an OFDM system with phase noise for a large DFT size. Plot 504 shows the performance of an OFDM system with phase noise compensation for a large DFT size (plots 502 and 504 are approximately overlapping). Plot 506 shows the performance of an OFDM system with phase noise and a small DFT size. Plot 508 shows the performance of an OFDM system with phase noise compensation and a small DFT size.

Plot 510 shows the performance of an SC-FDE system with phase noise for a large DFT size. Plot 512 shows the performance of an SC-FDE system with phase noise compensation for a large DFT size. Plot 514 shows the performance of an SC-FDE system with phase noise and a small DFT size. Plot 516 shows the performance of an SC-FDE system with phase noise compensation and a small DFT size.

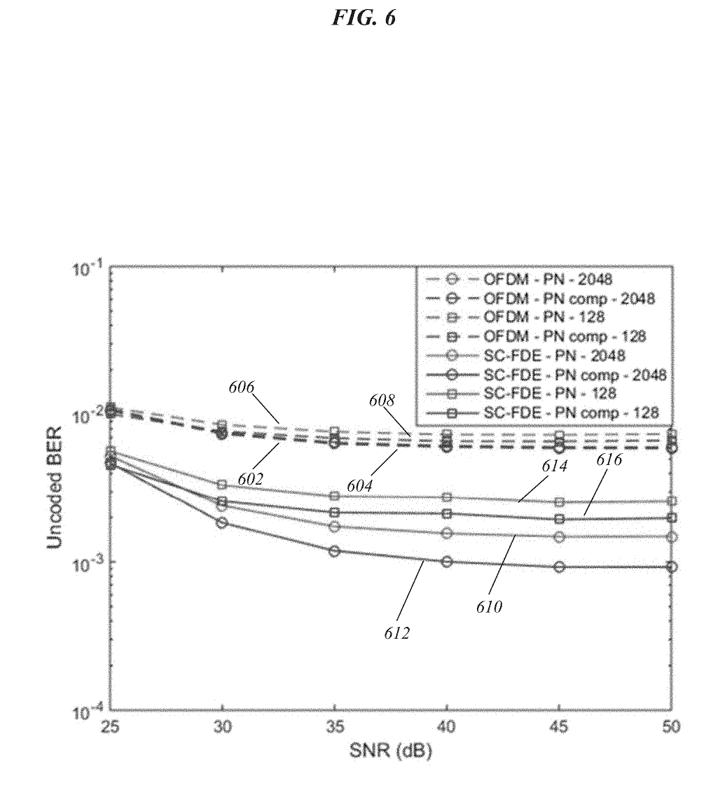

FIG. 6 illustrates the performance of SC-FDE and OFDM systems in the presence of phase noise for a non-line of sight (NLOS) channel, with a large DFT size (2048) and a small DFT size (128), with 16-QAM. Plot 602 shows the performance of an OFDM system with phase noise for a large DFT size. Plot 604 shows the performance of an OFDM system with phase noise compensation for a large DFT size (plots 602 and 604 are approximately overlapping). Plot 606 shows the performance of an OFDM system with phase noise and a small DFT size. Plot 608 shows the performance of an OFDM system with phase noise compensation and a small DFT size.

Plot 610 shows the performance of an SC-FDE system with phase noise for a large DFT size. Plot 612 shows the performance of an SC-FDE system with phase noise compensation for a large DFT size. Plot 614 shows the performance of an SC-FDE system with phase noise and a small DFT size. Plot 616 shows the performance of an SC-FDE system with phase noise compensation and a small DFT size.

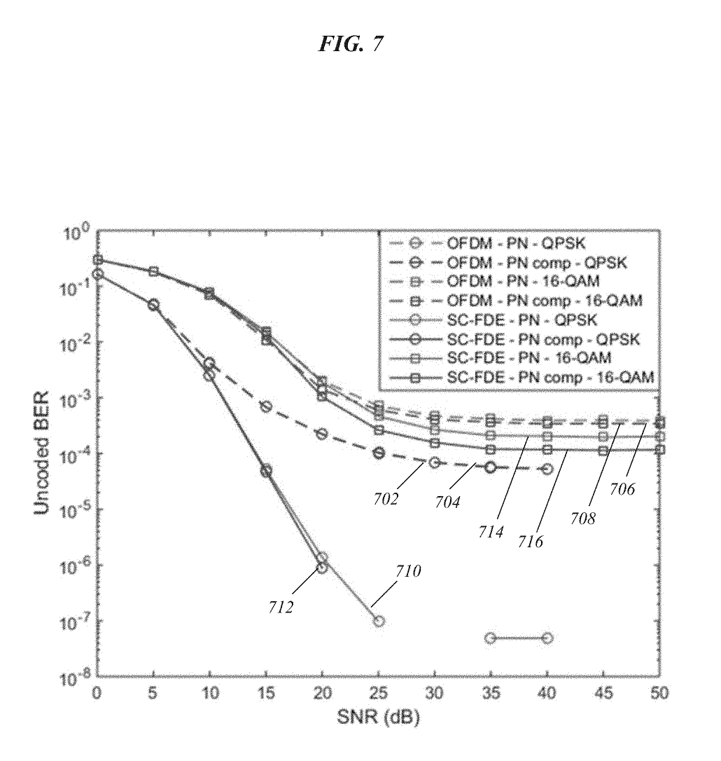

FIG. 7 illustrates the performance of SC-FDE and OFDM systems in the presence of phase noise for a line of sight (LOS) channel, with a large DFT size (2048), and either QPSK or 16-QAM. Plot 702 shows the performance of an OFDM system with phase noise using QPSK. Plot 704 shows the performance of an OFDM system with phase noise compensation using QPSK (plots 702 and 704 are approximately overlapping). Plot 706 shows the performance of an OFDM system with phase noise using 16-QAM. Plot 708 shows the performance of an OFDM system with phase noise compensation using 16-QAM.

Plot 710 shows the performance of an SC-FDE system with phase noise using QPSK. Plot 712 shows the performance of an SC-FDE system with phase noise compensation using QPSK. Plot 714 shows the performance of an SC-FDE system with phase noise using 16-QAM. Plot 716 shows the performance of an SC-FDE system with phase noise compensation using 16-QAM.

For each of the performance plots shown in FIGS. 2-7, the phase noise model proposed by IEEE 802.15.3c (single-pole, single zero) with a level of −85 dBc/Hz at 1 MHz offset was used. Further, for phase noise mitigation in the SC-FDE systems shown, the procedure (e.g., tracking and mitigation by interpolation) described in U.S. patent application Ser. No. 15/080,034, filed Mar. 24, 2016, hereby incorporated by reference in its entirety, was used. For OFDM systems, only the common phase error (CPE) was compensated (that is, no inter carrier interference equalization was used). For frequency-selective channels, Minimum Mean-Square Error (MMSE) equalization was performed. Further, in each of the FIGS. 2-7, performance of the systems are shown on a plot having an x-axis of signal to noise ratio (SNR) expressed in decibels (dB) and a y-axis of uncoded bit error rate (BER).

FIGS. 4-7 show performance comparisons when operating in a frequency selective channel. A number of features are shown by the performance plots shown in FIGS. 4-7. First, when the phase noise level is low or approximately negligible, SC-FDE schemes take better advantage of channel selectivity than OFDM systems. This is evident from the results shown in FIG. 4. Second, when a noticeable level of phase noise is present, for the two frequency-selective channel models (LoS and NLoS) and two DFT sizes (128 and 2048) considered, SC-FDE outperforms OFDM, both when phase noise mitigation is used and when it is not used. Third, FIG. 5 shows that the error floor due to phase noise for SC-FDE decreases by a factor of approximately ‘4’ when the DFT size increases (from 128 to 2048). This is caused by keeping the same pilot overhead percentage under both scenarios (e.g., 12.5%), resulting in more reference symbols being available for the 2048 case, thereby providing better phase noise mitigation.

Third, for highly dispersive channels (e.g., NLoS channels; see FIG. 6), the signal distortion introduced by the channel becomes more pronounced. As can be seen in FIG. 6, although phase noise tracking and mitigation still improves the system performance, the improvement obtained is reduced (when compared to the LoS case of FIG. 5). Fourth, as expected, the impact of phase noise to the system performance is heavily dependent on the modulation order. As shown in FIG. 7 for a LoS channel, the error floor obtained with QPSK is much lower than that obtained with 16-QAM. When QPSK is used, for this particular channel model, phase noise mitigation is not necessary.

Overall, the performance plots and comparisons shown in FIGS. 2-7 show that certain modulation formats (e.g., in terms of using SC-FDE or OFDM, selecting a modulation order, and selecting a DFT size/sub-carrier spacing) are preferable for a given operating scenario. In particular, certain modulation formats show improved performance over other modulation formats depending on whether phase noise is negligible or not (or, more generally, on the user's phase noise profile, including power level), in addition to channel condition. Further, non-uniform constellations can be made more robust than conventional uniform constellations to phase noise (at the cost of increased demapper complexity).

Accordingly, in view of the performance plots and comparisons shown in FIGS. 2-7, techniques described herein provide for a base station or access point of a wireless system (e.g., the WCD 102 of FIG. 1) to determine a modulation format for a particular user (e.g., a station or mobile such as the WCD 104 of FIG. 2) based on the user's particular phase noise profile. In particular, for modulation format, the following features can be selected or adjusted based on the user's phase noise profile—SC-FDE or OFDM, uniform or non-uniform constellation, modulation order, and DFT size/sub-carrier spacing. Modulation format can also be based on a user's feedback as well as a particular noise profile category.

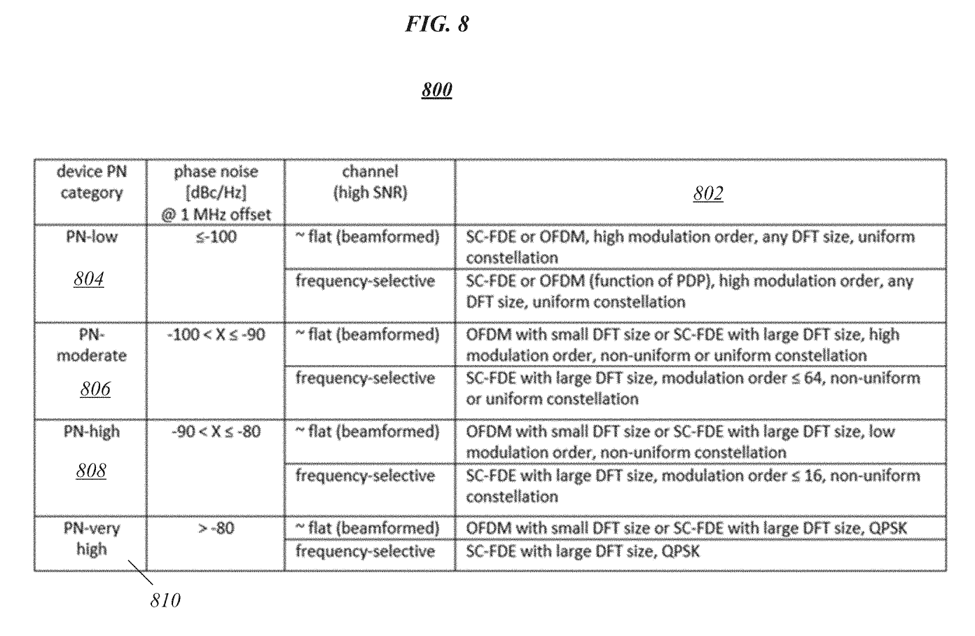

FIG. 8 illustrates a table 800 for selecting a modulation format 802 for a user in a millimeter-wave wireless system based on the phase noise category or profile of the user. The table 800 can assume high SNR during operation. Users can be categorized according to one of four noise categories 804-810. The embodiments are not limited to this particular number of categories as any number of noise categories can be established. Phase noise category 804 corresponds to a phase noise level of less than or equal to −100 dBc/Hz at 1 MHz offset. Phase noise category 806 corresponds to a phase noise level of greater than −100 and less than or equal to −90 dBc/Hz at 1 MHz offset. Phase noise category 808 corresponds to a phase noise level of greater than −90 and less than or equal to −80 dBc/Hz at 1 MHz offset. Phase noise category 810 corresponds to a phase noise level of greater than −80 dBc/Hz at 1 MHz offset. Each of the phase noise categories 804-810 are based on exemplary phase noise levels and are not limited to the specific values listed in FIG. 8 (i.e., any number of phase noise categories can be established based on any phase noise level values).

In general, a device (e.g., the WCD 104) can be classified according to the phase noise level (dBc/Hz) at 1 MHz offset of the device's particular individual implementation. Modulation format choices—e.g., whether to implement SC-FDE or OFDM, whether to use a relatively high or low modulation order, whether to use a relatively large or small DFT size, and whether to use a uniform or non-uniform constellation—can then be made based on the phase noise level classification. Further distinctions can be made based on channel type—e.g., whether the channel is approximately flat (e.g., non-frequency selective) or frequency selective. Overall, the modulation format used to serve a given user (e.g., as determined by a base station or access point) is at least in part determined by the user's phase noise level and/or characteristics. Each user in the network can be separately and independent categorized such that a modulation format for a user is individualized.

As an example, if a given user shows a relatively high phase noise level at 1 MHz offset—e.g., −78 dBc/Hz at 1 MHz offset (corresponding to category 810)—and the channel is frequency-selective, table 800 shows that the modulation format to select can be SC-FDE, with a large DFT size (e.g., in order to include more pilots that allow tracking and mitigation of the phase noise process), and a low-order modulation (e.g., QPSK). As another example, a user that experiences moderate phase noise levels—e.g., −95 dBc/Hz at 1 MHz offset (corresponding to category 806)—may be served using a non-uniform constellation. According to the techniques described herein, preference can be given to uniform constellations due to lower demapper complexity associated with implementing uniform constellations. In general, techniques described in U.S. patent application Ser. No. 15/080,034, filed Mar. 24, 2016 can be used to determine the phase noise level and/or category or profile of a user in a millimeter-wave wireless communication system.

Various embodiments can alternatively to or in addition to selecting modulation format in a static manner based on phase noise profile can use user feedback information to select or aid in the selection of a modulation format for a user. In various embodiments, depending on the operating scenario (e.g., in terms of temperature, noise level, and channel conditions) and the measured phase noise level, the user could request the base station or access point to use an appropriate modulation format. In various embodiments, the modulation format can be performed or determined on a user-by-user basis. That is, the base station or access point can transmit signals to different users by possibly using different modulation formats.

Various embodiments provide for users in a wireless network to be classified or categorized according to the user's phase noise characteristics. For example, users can be categorized based on the phase noise characteristics of the user's synthesizer. Any number of categories can be established. The categories can be established based on any number of thresholds based on any threshold values. As an example, users can be classified based on the following: for a phase noise level that is less than −100 dBc/MHz (at 1 MHz offset), the user can be classified as “PN-low”; for a phase noise level that is between −100 and −85 dBc/MHz (at 1 MHz offset), the user can be classified as “PN-moderate”; and for a phase noise level that is greater than −85 dBc/MHz (at 1 MHz offset), the user can be classified as “PN-High”. The phase noise classification can be determined in a number of ways including, for example, by the user device signaling a category to the base station or access point as a device capability or characteristic.

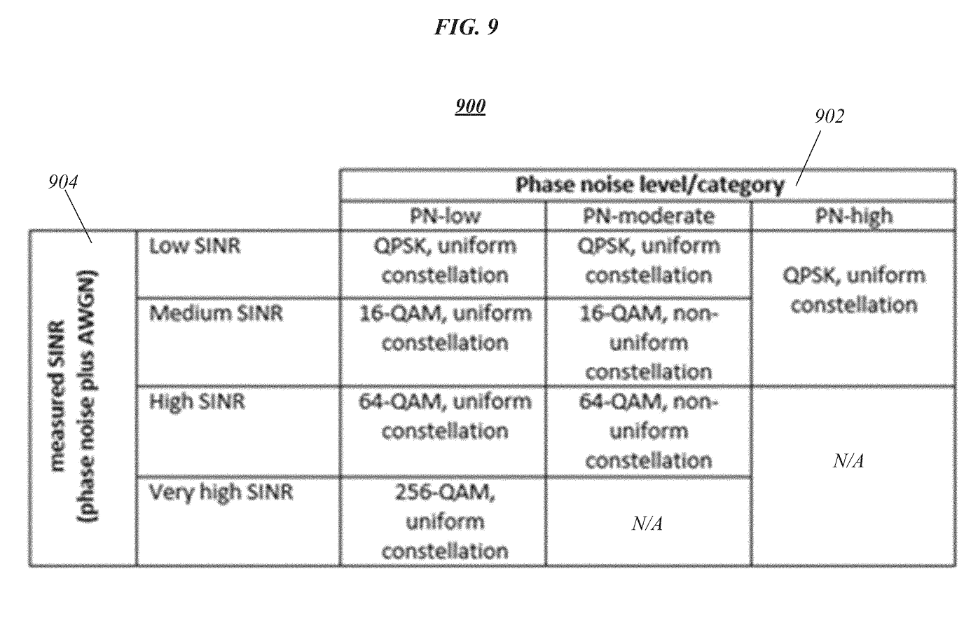

Based on the phase noise category of a user, a modulation coding scheme (MCS) for the user can be determined. The MCS can be partially dependent upon phase noise category and can also be based on other operating conditions of the user including, for example, SINR. FIG. 9 illustrates a table 900 for selecting a modulation format for a user in a millimeter-wave wireless system based on the phase noise category or profile of the user as well as the measured SINR associated with the user. A modulation format of the user can be selected based on a determined phase noise level or category 902 of the user as well as the determined category of the SINR of the user 904. As shown in FIG. 9, the measured SINR can include phase noise and AWGN. The phase noise categories 902 can be the categories stated above or can be varied or adjusted and are not limited to the particular threshold mentioned above. Modulation formats—e.g., in terms of modulation scheme (such as QPSK, 16-QAM, 64-QAM, and 256-QAM) and constellation type (such as uniform or non-uniform constellation)—can be determined based on determined SINR and phase noise category information. Based on these determinations, the reliability and quality of the communications of the user can be improved compared to adjusting modulation formation and/or MCS based solely on SINR. In the table 900, the not applicable entries (shown as “N/A”) represent scenarios that will not occur.

The SINR categories and corresponding SINR levels can be based on any number of SINR categories using any number of thresholds using any threshold values. As an example, the “Low SINR” category (for QPSK) can be based on an SINR value of approximately 11 dB for achieving a desired packet error rate (PER); the “Medium SINR” category (for 16 QAM) used in FIG. 9 can be based on an SINR value of approximately 17 dB for achieving a desired PER; the “High SINR” category (for 64 QAM) used in FIG. 9 can be based on an SINR value of approximately 24 dB for achieving a desired PER; and the “Very high SINR” category (for 256 QAM) used in FIG. 9 can be based on an SINR value of approximately 35 dB for achieving a desired PER. The modulation orders shown in FIGS. 8 and 9 are exemplary as any modulation order and modulation technique can be used based on the determined phase noise levels/categories and/or SINR levels/categories. As an example, modulation orders greater than 64 (e.g., 1024, 1024 QAM) can be used.

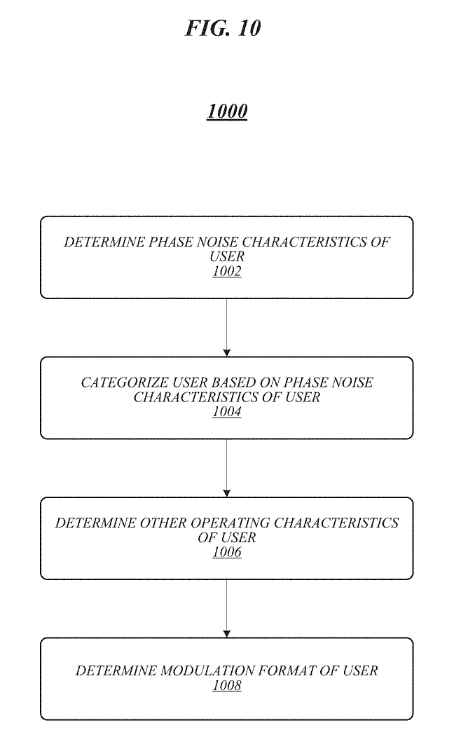

FIG. 10 illustrates an example of a logic flow 1000 that may be representative of the implementation of selecting modulation format for a user in a millimeter-wave wireless network in the presence of phase noise. For example, logic flow 100 may be representative of operations that may be performed in various embodiments by wireless communication device 102 and/or 104 in operating environment 100 of FIG. 1 and/or operations for implementing the modulation format selection techniques described in relation to FIGS. 8 and 9.

As shown in FIG. 10, at 1002, phase noise characteristics of a user can be determined. The user can operate within a millimeter-wave wireless network. The phase noise characteristics can be determined by a base station or an access point within the wireless network. The phase noise characteristics of the user can be signaled from the user to the base station and/or access point for example as part of a device characteristic or capability (e.g., based on the synthesizer of the user). As an example, the remote device can provide an indication to the base station or access point that indicates phase noise level, category, and/or characteristics of the remote device.

At 1004, the user can be categorized based on the determined phase noise characteristics of the user. Two or more phase noise categories can be established for classifying users. The categories can be based on any number of thresholds. That is, categories can be established based on thresholds and a classification can be made by comparing the user's phase noise level characteristics to the thresholds. The phase noise categories can be, for example, the categories shown and described in relation to FIGS. 8 and/or 9.

At 1006, additional operating characteristics of the user can be determined. For example, it can be determined if the user is operating over a channel that is approximately flat or a channel that is frequency selective. As another example, it can be determined if the user is operating with a relatively low SINR or a relatively high SINR (for example, as shown and described in relation to FIG. 9). SINR can be a measured SINR that includes phase noise plus AWGN. As an example, the remote device can provide an indication to the base station or access point that indicates SINR of the remote device.

At 1008, a modulation format for the user can be determined. The modulation format can dictate the characteristics of signals transmitted to the user. The modulation format can be based on the phase noise category determined in 1004 and/or the additional operating characteristics determined in 1008. The modulation format of a user can include determine a modulation scheme, a modulation order, a type of constellation, a DFT size, a subcarrier spacing, and a type of modulation technique (as described in relation to FIGS. 8 and 9 above). The embodiments are not limited to these examples.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc. The embodiments are not limited in this context.

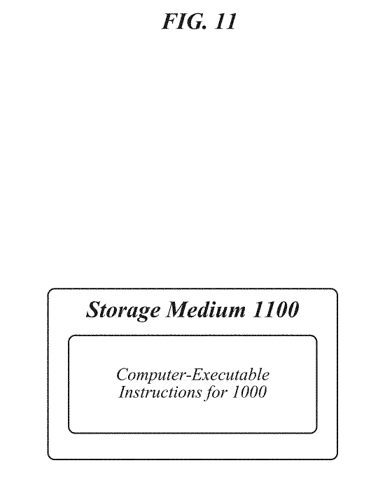

FIG. 11 illustrates an embodiment of a storage medium 1100. Storage medium 1100 may comprise any non-transitory computer-readable storage medium or machine-readable storage medium, such as an optical, magnetic or semiconductor storage medium. In various embodiments, storage medium 1100 may comprise an article of manufacture. In some embodiments, storage medium 1100 may store computer-executable instructions, such as computer-executable instructions to implement logic flow 1000 of FIG. 10. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

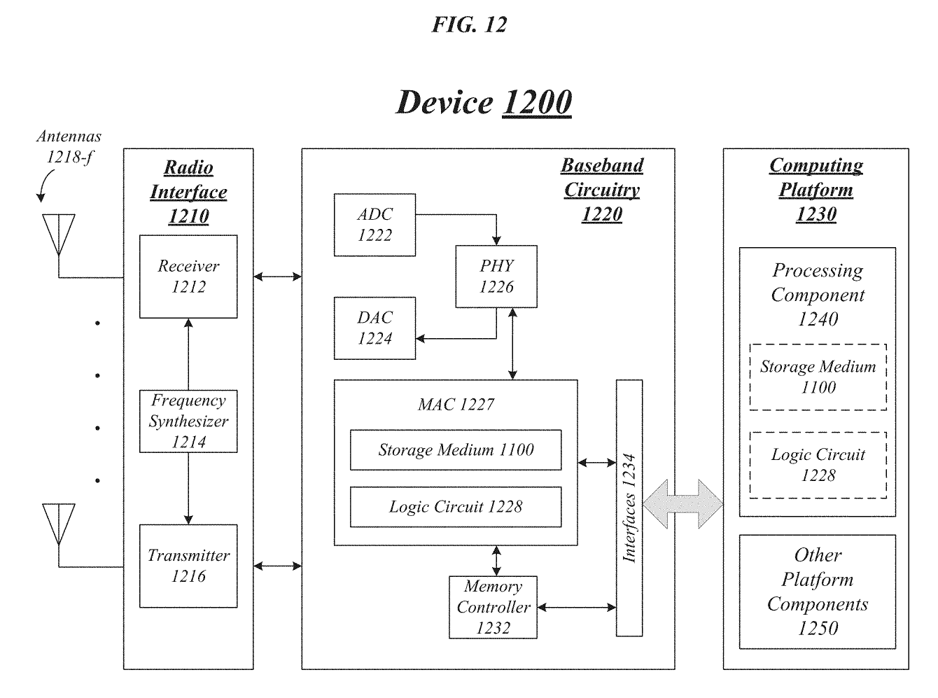

FIG. 12 illustrates an embodiment of a communications device 1200 that may implement one or more of wireless communication device 102, wireless communication device 104, logic flow 1000, and storage medium 1100. In various embodiments, device 1200 may comprise a logic circuit 1228. The logic circuit 1228 may include physical circuits to perform operations described for one or more of wireless communication device 102, wireless communication device 104, and logic flow 1000, for example. As shown in FIG. 12, device 1200 may include a radio interface 1210, baseband circuitry 1220, and computing platform 1230, although the embodiments are not limited to this configuration.

The device 1200 may implement some or all of the structure and/or operations for one or more of wireless communication device 102, wireless communication device 104, logic flow 1000, storage medium 1100, and logic circuit 1228 in a single computing entity, such as entirely within a single device. Alternatively, the device 1200 may distribute portions of the structure and/or operations for one or more of wireless communication device 102, wireless communication device 104, logic flow 1000, storage medium 1100, and logic circuit 1228 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1210 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1210 may include, for example, a receiver 1212, a frequency synthesizer 1214, and/or a transmitter 1216. Radio interface 1210 may include bias controls, a crystal oscillator and/or one or more antennas 1218-f. In another embodiment, radio interface 1210 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1220 may communicate with radio interface 1210 to process receive and/or transmit signals and may include, for example, an analog-to-digital converter 1222 for down converting received signals, a digital-to-analog converter 1224 for up converting signals for transmission. Further, baseband circuitry 1220 may include a baseband or physical layer (PHY) processing circuit 1226 for PHY link layer processing of respective receive/transmit signals. Baseband circuitry 1220 may include, for example, a medium access control (MAC) processing circuit 1227 for MAC/data link layer processing. Baseband circuitry 1220 may include a memory controller 1232 for communicating with MAC processing circuit 1227 and/or a computing platform 1230, for example, via one or more interfaces 1234.

In some embodiments, PHY processing circuit 1226 may include a frame construction and/or detection module, in combination with additional circuitry such as a buffer memory, to construct and/or deconstruct communication frames. Alternatively or in addition, MAC processing circuit 1227 may share processing for certain of these functions or perform these processes independent of PHY processing circuit 1226. In some embodiments, MAC and PHY processing may be integrated into a single circuit.

The computing platform 1230 may provide computing functionality for the device 1200. As shown, the computing platform 1230 may include a processing component 1240. In addition to, or alternatively of, the baseband circuitry 1220, the device 1200 may execute processing operations or logic for one or more of wireless communication device 102, wireless communication device 104, logic flow 1000, storage medium 1100, and logic circuit 1228 using the processing component 1240. The processing component 1240 (and/or PHY 1226 and/or MAC 1227) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1230 may further include other platform components 1250. Other platform components 1250 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1200 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1200 described herein, may be included or omitted in various embodiments of device 1200, as suitably desired.

Embodiments of device 1200 may be implemented using single input single output (SISO) architectures. However, certain implementations may include multiple antennas (e.g., antennas 1218-f) for transmission and/or reception using adaptive antenna techniques for beamforming or spatial division multiple access (SDMA) and/or using MIMO communication techniques.

The components and features of device 1200 may be implemented using any combination of discrete circuitry, application specific integrated circuits (ASICs), logic gates and/or single chip architectures. Further, the features of device 1200 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1200 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

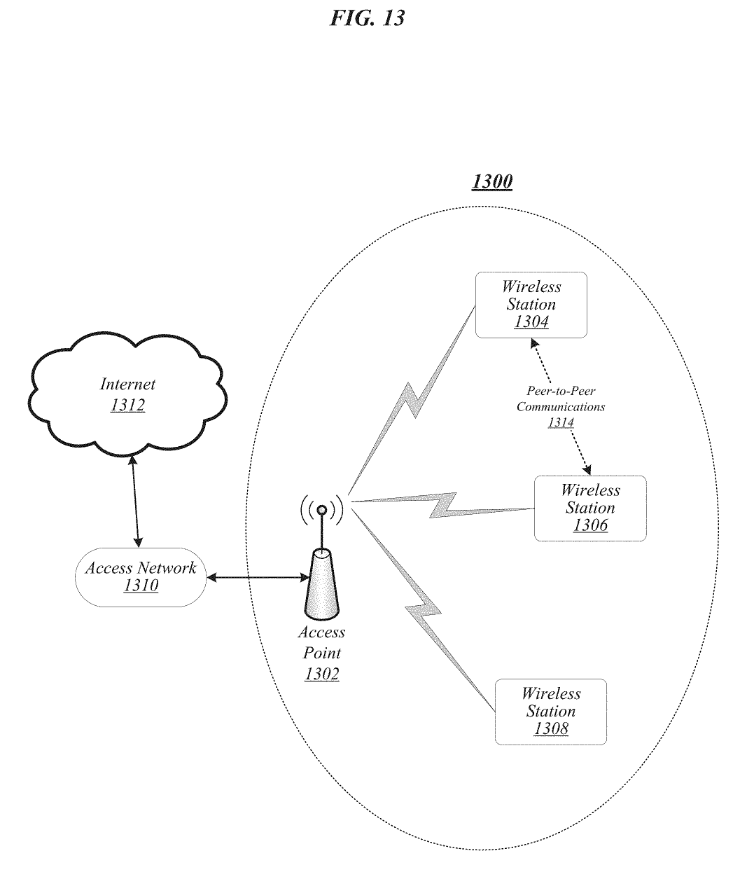

FIG. 13 illustrates an embodiment of a wireless network 1300. As shown in FIG. 13, wireless network comprises an access point 1302 and wireless stations 1304, 1306, and 1308. In various embodiments, wireless network 1300 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 1300 may comprise another type of wireless network, and/or may implement other wireless communications standards. In various embodiments, for example, wireless network 1300 may comprise a WWAN or WPAN rather than a WLAN. The embodiments are not limited to this example.

In some embodiments, wireless network 1300 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In some embodiments, wireless network 1300 may implement one or more wireless standards mentioned above in relation to FIG. 1 including, for example, a millimeter-wave wireless communication system. Further, in various embodiments, wireless network 1300 may implement a wireless standard such as 802.11ad and/or 802.11ay.

In various embodiments, wireless stations 1304, 1306, and 1308 may communicate with access point 1302 in order to obtain connectivity to one or more external data networks. In some embodiments, for example, wireless stations 1304, 1306, and 1308 may connect to the Internet 1312 via access point 1302 and access network 1310. In various embodiments, access network 1310 may comprise a private network that provides subscription-based Internet-connectivity, such as an Internet Service Provider (ISP) network. The embodiments are not limited to this example.

In various embodiments, two or more of wireless stations 1304, 1306, and 1308 may communicate with each other directly by exchanging peer-to-peer communications. For example, in the example of FIG. 13, wireless stations 1304 and 1306 communicate with each other directly by exchanging peer-to-peer communications 1314. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is an apparatus, comprising a memory and baseband circuitry coupled to the memory, the baseband circuitry to determine a phase noise level for a remote device, determine a signal-to-interference-plus-noise ratio (SINR) for the remote device, select a modulation format for the remote device based on the determined phase noise level and SINR for the remote device, and generate a signal for transmission to the remote device via a millimeter-wave wireless carrier based on the selected modulation format.

Example 2 is an extension of Example 1 or any other example disclosed herein, an indication of the phase noise level for the remote device provided by the remote device.

Example 3 is an extension of Example 1 or any other example disclosed herein, an indication of the SINR for the remote device provided by the remote device.

Example 4 is an extension of Example 1 or any other example disclosed herein, the baseband circuitry to determine a phase noise category for the remote device based on the phase noise level for the remote device.

Example 5 is an extension of Example 4 or any other example disclosed herein, a first phase noise category corresponding to the phase noise level of less than −100 dBc/MHz at a 1 MHz offset.

Example 6 is an extension of Example 5 or any other example disclosed herein, a second phase noise category corresponding to the phase noise level of between −100 and −85 dBc/MHz at a 1 MHz offset.

Example 7 is an extension of Example 6 or any other example disclosed herein, a third phase noise category corresponding to the phase noise level of greater than −85 dBc/MHz at a 1 MHz offset.

Example 8 is an extension of Example 4 or any other example disclosed herein, the baseband circuitry to determine an SINR category for the remote device based on the SINR for the remote device.

Example 9 is an extension of Example 8 or any other example disclosed herein, the baseband circuitry to select the modulation format based on the phase noise category and the SINR category of the remote device.

Example 10 is an extension of Example 1 or any other example disclosed herein, the modulation format to include a modulation scheme.

Example 11 is an extension of Example 10 or any other example disclosed herein, the modulation scheme to comprise orthogonal frequency division multiplexing (OFDM).

Example 12 is an extension of Example 10 or any other example disclosed herein, the modulation scheme to comprise single-carrier frequency domain equalization (SC-FDE).

Example 13 is an extension of Example 1 or any other example disclosed herein, the modulation format to include a uniform signal constellation.

Example 14 is an extension of Example 1 or any other example disclosed herein, the modulation format to include a non-uniform signal constellation.

Example 15 is an extension of Example 1 or any other example disclosed herein, the modulation format to include a modulation order.

Example 16 is an extension of Example 15 or any other example disclosed herein, the modulation order based on quadrature phase shift keying (QPSK).

Example 17 is an extension of Example 15 or any other example disclosed herein, the modulation order based on 16-quadrature amplitude modulation (QAM).

Example 18 is an extension of Example 15 or any other example disclosed herein, the modulation order based on 64-QAM.

Example 19 is an extension of Example 15 or any other example disclosed herein, the modulation order based on 256-QAM.

Example 20 is an extension of Example 1 or any other example disclosed herein, the modulation format to include an adjustable subcarrier spacing.

Example 21 is an extension of Example 1 or any other example disclosed herein, the baseband circuitry to determine a channel type for the remote device.

Example 22 is an extension of Example 21 or any other example disclosed herein, the channel type to include an approximately flat channel.

Example 23 is an extension of Example 21 or any other example disclosed herein, the channel type to include a frequency-selective channel.

Example 24 is an extension of any of Examples 1 to 23 or any other example disclosed herein, the apparatus comprising at least one radio frequency (RF) transceiver and at least on RF antenna.

Example 25 is a wireless communication method, comprising determining a phase noise level for a remote device, determining a signal-to-interference-plus-noise ratio (SINR) for the remote device, selecting a modulation format for the remote device based on the determined phase noise level and SINR for the remote device, and generating a signal for transmission to the remote device via a millimeter-wave wireless carrier based on the selected modulation format.

Example 26 is an extension of Example 25 or any other example disclosed herein, an indication of the phase noise level for the remote device provided by the remote device.

Example 27 is an extension of Example 25 or any other example disclosed herein, an indication of the SINR for the remote device provided by the remote device.

Example 28 is an extension of Example 25 or any other example disclosed herein, determining a phase noise category for the remote device based on the phase noise level for the remote device.

Example 29 is an extension of Example 28 or any other example disclosed herein, a first phase noise category corresponding to the phase noise level of less than −100 dBc/MHz at a 1 MHz offset.

Example 30 is an extension of Example 29 or any other example disclosed herein, a second phase noise category corresponding to the phase noise level of between −100 and −85 dBc/MHz at a 1 MHz offset.

Example 31 is an extension of Example 30 or any other example disclosed herein, a third phase noise category corresponding to the phase noise level of greater than −85 dBc/MHz at a 1 MHz offset.

Example 32 is an extension of Example 28 or any other example disclosed herein, determining an SINR category for the remote device based on the SINR for the remote device.

Example 33 is an extension of Example 32 or any other example disclosed herein, selecting the modulation format based on the phase noise category and the SINR category of the remote device.

Example 34 is an extension of Example 25 or any other example disclosed herein, the modulation format to include a modulation scheme.

Example 35 is an extension of Example 34 or any other example disclosed herein, the modulation scheme to comprise orthogonal frequency division multiplexing (OFDM).

Example 36 is an extension of Example 34 or any other example disclosed herein, the modulation scheme to comprise single-carrier frequency domain equalization (SC-FDE).

Example 37 is an extension of Example 25 or any other example disclosed herein, the modulation format to include a uniform signal constellation.

Example 38 is an extension of Example 25 or any other example disclosed herein, the modulation format to include a non-uniform signal constellation.

Example 39 is an extension of Example 25 or any other example disclosed herein, the modulation format to include a modulation order.

Example 40 is an extension of Example 39 or any other example disclosed herein, the modulation order based on quadrature phase shift keying (QPSK).

Example 41 is an extension of Example 39 or any other example disclosed herein, the modulation order based on 16-quadrature amplitude modulation (QAM).

Example 42 is an extension of Example 39 or any other example disclosed herein, the modulation order based on 64-QAM.

Example 43 is an extension of Example 39 or any other example disclosed herein, the modulation order based on 256-QAM.

Example 44 is an extension of Example 25 or any other example disclosed herein, the modulation format to include an adjustable subcarrier spacing.

Example 45 is an extension of Example 25 or any other example disclosed herein, determining a channel type for the remote device.

Example 46 is an extension of Example 45 or any other example disclosed herein, the channel type to include an approximately flat channel.

Example 47 is an extension of Example 45 or any other example disclosed herein, the channel type to include a frequency-selective channel.

Example 48 is at least one computer-readable storage medium comprising a set of instructions that, in response to being executed on a computing device, cause the computing device to perform a wireless communication method according to any of Examples 25 to 47 or any other example disclosed herein.

Example 49 is an apparatus comprising means for performing a wireless communication method according to any of Examples 25 to 47 or any other example disclosed herein.

Example 50 is at least one non-transitory computer-readable medium comprising a set of instructions that, in response to being executed at a wireless communication device, cause the wireless communication device to determine a phase noise level for a remote device, determine a signal-to-interference-plus-noise ratio (SINR) for the remote device, select a modulation format for the remote device based on the determined phase noise level and SINR for the remote device, and generate a signal for transmission to the remote device via a millimeter-wave wireless carrier based on the selected modulation format.

Example 51 is an extension of Example 50 or any other example disclosed herein, an indication of the phase noise level for the remote device provided by the remote device.

Example 52 is an extension of Example 50 or any other example disclosed herein, an indication of the SINR for the remote device provided by the remote device.

Example 53 is an extension of Example 50 or any other example disclosed herein, comprising instructions that, in response to being executed on the wireless communication device, cause the wireless communication device to determine a phase noise category for the remote device based on the phase noise level for the remote device.

Example 54 is an extension of Example 53 or any other example disclosed herein, a first phase noise category corresponding to the phase noise level of less than −100 dBc/MHz at a 1 MHz offset.

Example 55 is an extension of Example 54 or any other example disclosed herein, a second phase noise category corresponding to the phase noise level of between −100 and −85 dBc/MHz at a 1 MHz offset.

Example 56 is an extension of Example 55 or any other example disclosed herein, a third phase noise category corresponding to the phase noise level of greater than −85 dBc/MHz at a 1 MHz offset.

Example 57 is an extension of Example 53 or any other example disclosed herein, comprising instructions that, in response to being executed on the wireless communication device, cause the wireless communication device to determine an SINR category for the remote device based on the SINR for the remote device.

Example 58 is an extension of Example 57 or any other example disclosed herein, comprising instructions that, in response to being executed on the wireless communication device, cause the wireless communication device to select the modulation format based on the phase noise category and the SINR category of the remote device.

Example 59 is an extension of Example 50 or any other example disclosed herein, the modulation format to include a modulation scheme.

Example 60 is an extension of Example 59 or any other example disclosed herein, the modulation scheme to comprise orthogonal frequency division multiplexing (OFDM).

Example 61 is an extension of Example 59 or any other example disclosed herein, the modulation scheme to comprise single-carrier frequency domain equalization (SC-FDE).

Example 62 is an extension of Example 50 or any other example disclosed herein, the modulation format to include a uniform signal constellation.

Example 63 is an extension of Example 50 or any other example disclosed herein, the modulation format to include a non-uniform signal constellation.

Example 64 is an extension of Example 50 or any other example disclosed herein, the modulation format to include a modulation order.

Example 65 is an extension of Example 64 or any other example disclosed herein, the modulation order based on quadrature phase shift keying (QPSK).

Example 66 is an extension of Example 64 or any other example disclosed herein, the modulation order based on 16-quadrature amplitude modulation (QAM).

Example 67 is an extension of Example 64 or any other example disclosed herein, the modulation order based on 64-QAM.

Example 68 is an extension of Example 64 or any other example disclosed herein, the modulation order based on 256-QAM.

Example 69 is an extension of Example 50 or any other example disclosed herein, the modulation format to include an adjustable subcarrier spacing.

Example 70 is an extension of Example 50 or any other example disclosed herein, determining a channel type for the remote device.

Example 71 is an extension of Example 70 or any other example disclosed herein, the channel type to include an approximately flat channel.

Example 72 is an extension of Example 70 or any other example disclosed herein, the channel type to include a frequency-selective channel.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a memory; and
baseband circuitry coupled to the memory, the baseband circuitry to:
determine a phase noise level for a remote device;
determine a signal-to-interference-plus-noise ratio (SINR) for the remote device;
select a modulation format for the remote device based on the determined phase noise level and SINR for the remote device; and
generate a signal for transmission to the remote device via a millimeter-wave wireless carrier based on the selected modulation format.

2. The apparatus of claim 1, an indication of the phase noise level for the remote device provided by the remote device.

3. The apparatus of claim 1, an indication of the SINR for the remote device provided by the remote device.

4. The apparatus of claim 1, the baseband circuitry to determine a phase noise category for the remote device based on the phase noise level for the remote device.

5. The apparatus of claim 4, a first phase noise category corresponding to the phase noise level of less than −100 dBc/MHz at a 1 MHz offset.

6. The apparatus of claim 5, a second phase noise category corresponding to the phase noise level of between −100 and −85 dBc/MHz at a 1 MHz offset.

7. The apparatus of claim 6, a third phase noise category corresponding to the phase noise level of greater than −85 dBc/MHz at a 1 MHz offset.

8. The apparatus of claim 4, the baseband circuitry to determine an SINR category for the remote device based on the SINR for the remote device.

9. The apparatus of claim 8, the baseband circuitry to select the modulation format based on the phase noise category and the SINR category of the remote device.

10. The apparatus of claim 1, the modulation format to include a uniform signal constellation.

11. The apparatus of claim 1, the modulation format to include a non-uniform signal constellation.

12. The apparatus of claim 1, the modulation format to include a modulation order.

13. The apparatus of claim 12, the modulation order based on quadrature phase shift keying (QPSK).

14. The apparatus of claim 12, the modulation order based on 16-quadrature amplitude modulation (QAM).

15. The apparatus of claim 12, the modulation order based on 64-QAM.

16. The apparatus of claim 12, the modulation order based on 256-QAM.

17. At least one non-transitory computer-readable medium comprising a set of instructions that, in response to being executed at a wireless communication device, cause the wireless communication device to:
determine a phase noise level for a remote device;
determine a signal-to-interference-plus-noise ratio (SINR) for the remote device;
select a modulation format for the remote device based on the determined phase noise level and SINR for the remote device; and
generate a signal for transmission to the remote device via a millimeter-wave wireless carrier based on the selected modulation format.

18. The at least one non-transitory computer-readable medium of claim 17, an indication of the phase noise level for the remote device provided by the remote device.

19. The at least one non-transitory computer-readable medium of claim 17, an indication of the SINR for the remote device provided by the remote device.

20. The at least one non-transitory computer-readable medium of claim 17, comprising instructions that, in response to being executed on the wireless communication device, cause the wireless communication device to determine a phase noise category for the remote device based on the phase noise level for the remote device.

21. The at least one non-transitory computer-readable medium of claim 20, a first phase noise category corresponding to the phase noise level of less than −100 dBc/MHz at a 1 MHz offset.

22. The at least one non-transitory computer-readable medium of claim 21, a second phase noise category corresponding to the phase noise level of between −100 and −85 dBc/MHz at a 1 MHz offset.

23. The at least one non-transitory computer-readable medium of claim 21, a third phase noise category corresponding to the phase noise level of greater than −85 dBc/MHz at a 1 MHz offset.

24. The at least one non-transitory computer-readable medium of claim 20, comprising instructions that, in response to being executed on the wireless communication device, cause the wireless communication device to determine an SINR category for the remote device based on the SINR for the remote device.

25. The at least one non-transitory computer-readable medium of claim 24, comprising instructions that, in response to being executed on the wireless communication device, cause the wireless communication device to select the modulation format based on the phase noise category and the SINR category of the remote device.
